(19) United States
(12) Patent Application Publication
(10) Pub. No.: US 2005/0187903 A1
(43) Pub. Date: Aug. 25, 2005

(54) Device and method for notifying of used area, and medium storing program therefor

(76) Inventors: Yukiko Inoue, Kadoma City (JP); Makoto Ochi, Hirakata City (JP); Kazuya Fujimura, Ikoma City (JP); Shinji Inoue, Neyagawa City (JP); Hirokazu Sou, Moriguchi City (JP); Masato Suto, Neyagawa City (JP); Takuji Maeda, Neyagawa City (JP)

Correspondence Address: SMITH PATENT OFFICE, 1901 PENNSYLVANIA AVENUE N W, SUITE 200, WASHINGTON, DC, 20006, US

(21) Appl. No.: 10/996,605

(22) Filed: Nov. 26, 2004

(30) Foreign Application Priority Data
Nov. 26, 2003 (JP) 2003-395200

(51) Int. Cl. G06F 7/00

(52) U.S. Cl. 707/2

(57) ABSTRACT

Areas in an information medium 507 having a plurality of information storing areas 506 which are managed by different file systems are switched by means of a display control part 502 and a medium control part 503, and information for clearly notifying the utilized information storing area 506 from the information medium 507 is displayed on a display part 501. In addition, a switched areas notifying part 508 is provided in order to notify to a user that the area has switched using a mode of display, sound, light or the like.

### BACKGROUND OF THE INVENTION

1. Field of the Invention

The present invention relates to a device and a method for notifying of used areas concerning a display of information on an information medium having a plurality of information storing areas, and to a medium storing a program therefor.

2. Discussion of the Related Art

Conventionally, management of data that has been stored in information storing areas on an information medium such as a semiconductor memory, a magnetic disc or an optical magnetic disc has been implemented by means of a predetermined file system.

A FAT file system is cited as an example of a conventionally utilized file system (“Information Technology-Volume and File Structure of Disk Cartridges for Information,” 1994). The FAT file system is a file system which is generally used in information apparatuses such as personal computers and has a feature in that a physical position of storage of data that forms a file is uniquely managed by using a table, which is referred to as a FAT (File Allocation Table). Information media of which data is managed using a file system such as the FAT file system allow a file to be shared by apparatuses that interpret the same file system; therefore, it becomes possible to transmit and receive data among the apparatuses.

However, as for file systems, a FAT 32 file system, a NTFS (NT File System), a UDF (Universal Disk Format) and the like exist besides the FAT file system. In addition, the respective apparatuses interpret a variety of file systems and data can not be transmitted and received among the apparatuses having different file systems for storing data even in the case the same information medium is shared by the plural apparatuses.

In order to solve this problem, a method for maintaining a convertibility of data among the respective apparatuses by constructing two or more file systems in the information medium can be considered. The information storing area within an information medium is for example, divided into a plurality of areas managed using different file systems, and an area information storing part for storing a plurality of pieces of information concerning the starting positions and the sizes of the respective areas is provided in the information medium and, thereby, it becomes possible to select the area that can be interpreted by a specific apparatus and to access this area from the outside from among the plurality of pieces of area information included in the area information storing part using a command inputted from the outside of this information medium.

In addition, in the case a digital copyrighted work is stored in an information medium, it is generally carried out to encrypt the digital copyrighted work with an encryption key in order to protect the copyright. In many cases, an encryption key used for this encryption is stored in a form which a user cannot read easily. As shown in JP-A 2003-233795, for example, a method for providing an area (hereinafter referred to as authenticated area) that requires a two-way authentication when the encryption is decoded to the inside of the medium so as to protect this area by storing an encryption key has been proposed.

However, the above conventional technique has the following problems.

Though it is necessary to access information in an information medium with a number of information storing areas which are to be accessed on the basis of different file systems while switching the file systems, there are no means for scanning all information storing areas that have been maintained in one information medium and the entirety of the information medium cannot be grasped.

In addition, in the case information stored on an information medium with a plurality of information storing areas is handled, the user cannot conventionally recognize the difference between the information storing areas in an apparatus such as a personal computer which displays contents of the information medium when the user needs to understand the area for usage.

Furthermore, though information is stored in an information medium that corresponds to copyright protection of digital copyrighted works with a authenticated area divided into a plurality of sections, difference in the authenticated area cannot conventionally be recognized in an apparatus such as a personal computer which displays contents of the information medium.

### SUMMARY OF THE INVENTION

In view of the above problems, the present invention provides an information medium with a plurality of information storing areas accessed on the basis of individual file systems and a device and a method for notifying of used areas that notify a user of different means for accessing an information medium where information is stored by dividing a authenticated area into a plurality of sections.

The present invention provides a device for notifying of used areas that accesses an information medium having a plurality of information storing areas managed using individual file systems, the device comprising: a medium control part which switches information storing areas for accessing said information medium; and a display control part which displays information in said plurality of information storing areas after said information storing areas have been switched to accessible areas.

The present invention also provides a method for notifying of used areas in a device for notifying of used areas that accesses an information medium having a plurality of information storing areas managed using individual file systems, the method comprising: a medium control step of switching said information storing areas for accessing said information medium; and a display control step of displaying information on said plurality of information storing areas after said information storing areas have been switched to accessible areas.

In accordance with the device and the method for notifying of used areas of the present invention, the contents of the plurality of information storing areas existing in one information medium can all be scanned.

### BRIEF DESCRIPTION OF THE DRAWINGS

FIG. 1 is a block diagram showing a configuration of an information displaying device and an information medium according to a first embodiment of the present invention;

FIG. 2 is a conceptual diagram of an information storing area according to the first embodiment;

FIG. 3 is a conceptual diagram showing an example of a display of the information storing area according to the first embodiment;

FIG. 4 is a flowchart showing an operation of a device for notifying of used areas according to the first embodiment;

FIG. 5 is a block diagram showing a configuration of an information displaying device and an information medium according to a second embodiment;

FIG. 6 is a flowchart showing an operation of a device for notifying of used areas according to the second embodiment;

FIG. 7 is a conceptual diagram showing an example of a display of an information storing area according to the second embodiment;

FIG. 8 is a block diagram showing a configuration of an information displaying device and an information medium according to a third embodiment;

FIG. 9A is a conceptual diagram showing an information storing area according to the third embodiment;

FIG. 9B is a conceptual diagram showing an information storing area according to a fourth embodiment;

FIG. 9C is a conceptual diagram showing an information storing area according to a fifth embodiment;

FIG. 10 is a conceptual diagram showing an example of a display of the information storing area according to the third embodiment;

FIG. 11 is a flowchart showing an operation of a device for notifying of used areas according to the fourth embodiment;

FIG. 12 is a block diagram showing a configuration of an information displaying device and an information medium according to the fifth embodiment;

FIG. 13 is a conceptual diagram showing an information storing area according to the fifth embodiment;

FIG. 14 is a conceptual diagram of a memory for area information according to the fifth embodiment; and

FIG. 15 is a block diagram showing a configuration of an information displaying device and an information medium according to a modification of the fifth embodiment.

### DESCRIPTION OF THE PREFERRED EMBODIMENTS

### First Embodiment

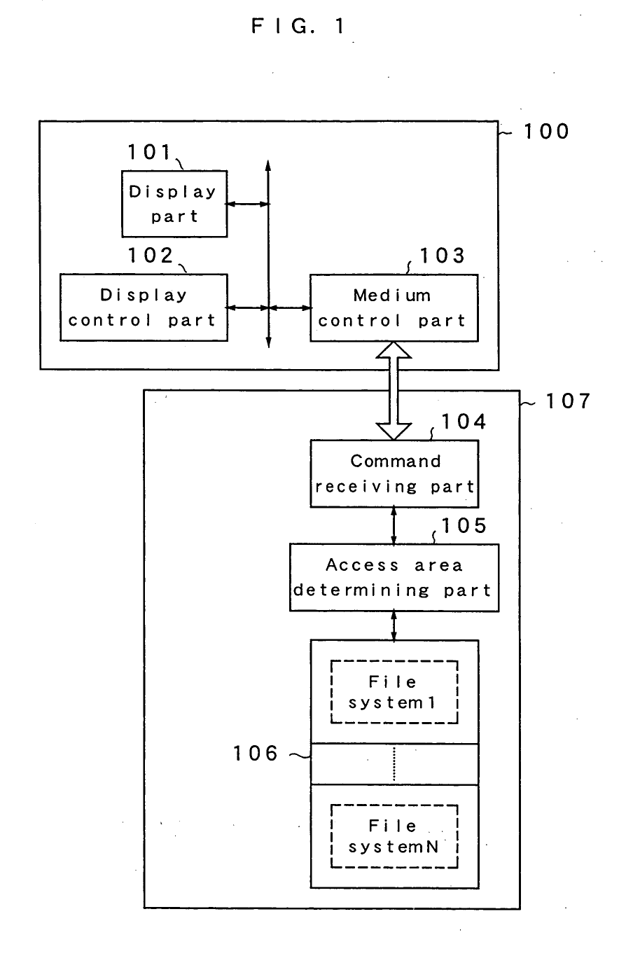

FIG. 1 is a block diagram showing a configuration of an information displaying device and an information medium according to a first embodiment of the present invention. In FIG. 1, an information displaying device 100 operates as a device for notifying of used areas and includes a display part 101, a display control part 102 and a medium control part 103. An information medium 107 includes a command receiving part 104, an access area determining part 105 and an information storing area 106 made up of 1 to N (N is an integer no less than 2) information storing areas.

Each block of the information displaying device and the information medium in such configurations is described below.

The display control part 102 designates an area of which the information should be displayed and outputs data concerning this area to the medium control part 103. The medium control part 103 issues a command to switch areas in order to access the area that has been designated by the display control part 102 and outputs the command to the command receiving part 104 of the information medium 107.

The command receiving part 104 receives a command from the medium control part 103 and the access area determining part 105 determines an access area on the basis of the command to switch areas. On the basis of the determination result by accessing the area determining part 105, the information medium 107 reads information on the designated area in the information storing area 106, which is outputted from the information medium 107 to the information displaying device 100. The information on the area that has been obtained from the information medium 107 is displayed on the display part 101 according to a displaying method designated by the display control part 102.

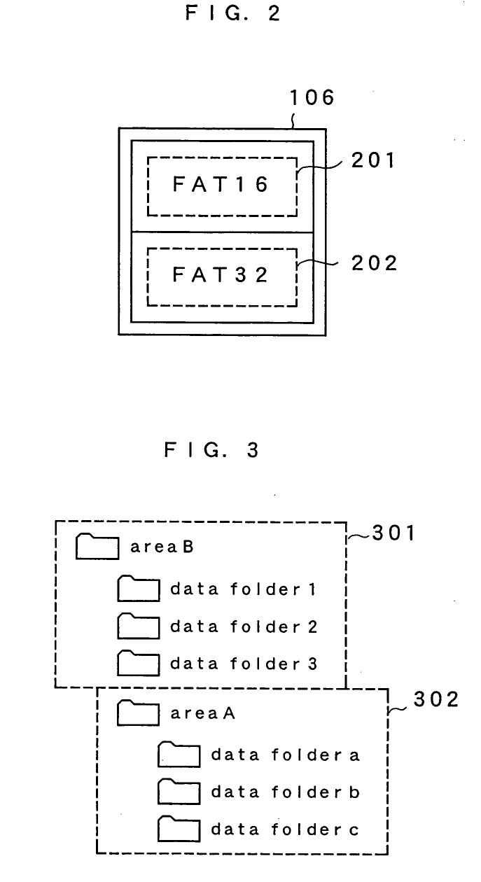

FIG. 2 is a conceptual diagram of an information storing area of the information medium 107 according to the first embodiment of the present invention. FIG. 2 shows an example of an information storing area which is controlled using two different file systems. The information storing area 106 shown in FIG. 2 includes an information storing area 201 which is controlled using a FAT 16 file system and an information storing area 202 which is controlled using a FAT 32 file system. In order to switch the access area from one area to another area, a command to switch the access areas must be sent from the outside of the information medium 107 so as to switch the areas.

FIG. 3 is an example of a display of an information storing area displayed on the display part 101. In FIG. 3, 301 indicates a folder that is stored in the information storing area 202 (area B) which is managed using the FAT 32 file system. 302 indicates a folder that is stored in the information storing area 201 (area A) which is managed using the FAT 16 file system. FIG. 3 shows an example of a display where the information managed using the FAT 16 file system is collected into one folder (area A in the figure) in the information managed using the FAT 32 file system.

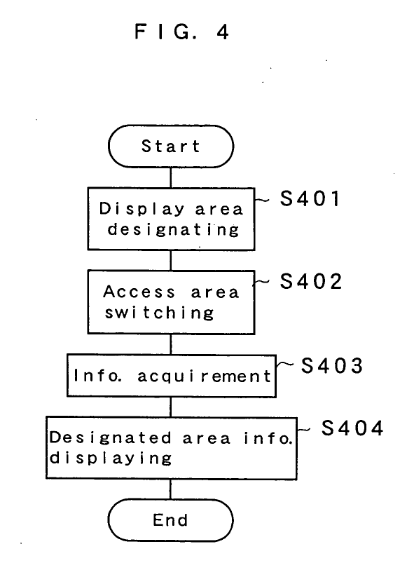

FIG. 4 is a flowchart showing the operations of the device for notifying of used area and the medium according to the first embodiment of the present invention. In the flowchart, the operations of the device for notifying of used area and the medium according to this embodiment are described with reference to FIG. 4.

A case where an application program for displaying a list of stored information is executed, for example, is described. In this case, first, a list of information that is stored in the information storing area managed by the FAT 32 file system is first acquired. First, the display control part 102 designates the area to be displayed, and issues a switching command that requires switching of the access areas to the information medium 107 from the medium control part 103 (S401). The FAT 32 file system is designated in the display control part 102 according to a predetermined control within the application, and the switching command for the information storing area 202 is transmitted from the medium control part 103 to the command receiving part 104 of the medium 107.

In the information medium 107, when the command receiving part 104 receives a switching command for the information storing area 202, the access areas are switched (S402). Next, the area is determined by the access area determining part 105, and information that is stored in the storage area 202 managed by the FAT 32 file system of the information storing area 106 is acquired and outputted from the information medium 107 to the information displaying device 100 (S403).

The area information acquired from the information medium 107 is displayed on the display part 101 according to the display method that has been determined by the display control part 102 (S404). The display part 101 displays a list of stored information in tree structure, for example, as shown in 301 of FIG. 3.

Next, a list of information that is stored in the information storing area managed by the FAT 16 file system is acquired in the same manner through the application. At this time, the FAT 16 file system is designated by the display control part 102, and steps S401 to S404 are carried out again. In S404, for example, as shown in 302 of FIG. 3, the information managed by the FAT 16 file system is collected into one folder, and displayed in the information managed by the FAT 32 file system. Thus, information managed by different file systems can be simultaneously displayed.

Here, though in this embodiment, an information medium with two information storing areas managed by the two file systems, the FAT 32 and the FAT 16, is cited, the filing systems are not limited to these two, but rather, may be an NTFS, a UDF or any other unique file system. In addition, the number of information recording areas is not limited to two, but rather, more than one information recording area can be implemented in the same manner by repeating S401 to S404 while switching the file systems.

In addition, the more than one information storing area may be managed by the same file system. This is considered to be a case where the FAT 16 file system is, for example, limited to 2 GB and an information medium has more than one area of the maximum capacity that can be handled by the FAT 16 file system.

In addition, though in this embodiment, an example is cited where the information displaying device 100 can access all of the information storing areas 106 that exist in the information medium 107, only the areas that can be accessed by the device from among the more than one information storing area may be selected and displayed. In the case of, for example, an information displaying device that has only the FAT 16 file system, only the information (area in 302 of FIG. 3) of the information storing area 201 of FIG. 2 is displayed, and in the case of an information displaying device that has the two file systems of FAT 16 and FAT 32, information of the two areas in 301 and 302 of FIG. 3 is displayed. Alternatively, in the case of an information displaying device that has the two file systems, it is possible for the display control part 102 to intentionally choose to display only one of the two areas, limiting access to an arbitrary area.

In addition, in this embodiment, the information storing areas are shown in a hierarchical manner. That is to say, the information managed by the FAT 16 file system is collected into one folder and displayed in the information managed by the FAT 32 file system. Alternatively, the information managed by the FAT 16 file system may be positioned at the same level as the information managed by the FAT 32 file system (one level above the tree structure). In addition, as long as the information within the area is displayed, a display method for aligning icons or any other display method may be used without providing a tree structure.

In addition, though in this embodiment, the access areas are switched by means of a command from the information displaying device 100, a mechanical switch is provided to the information medium so that this switch can be switched on the information displaying device side.

As described above, area information is acquired while switching the information storing areas, and the acquired information is displayed according to a desired method, and thereby, it becomes possible to display information in more than one storing area, even in the case an information medium has more than one information storing area managed by individual file systems. Also in the case there is more than one area that is managed by the same file system, information in more than one storing area can be displayed.

### Second Embodiment

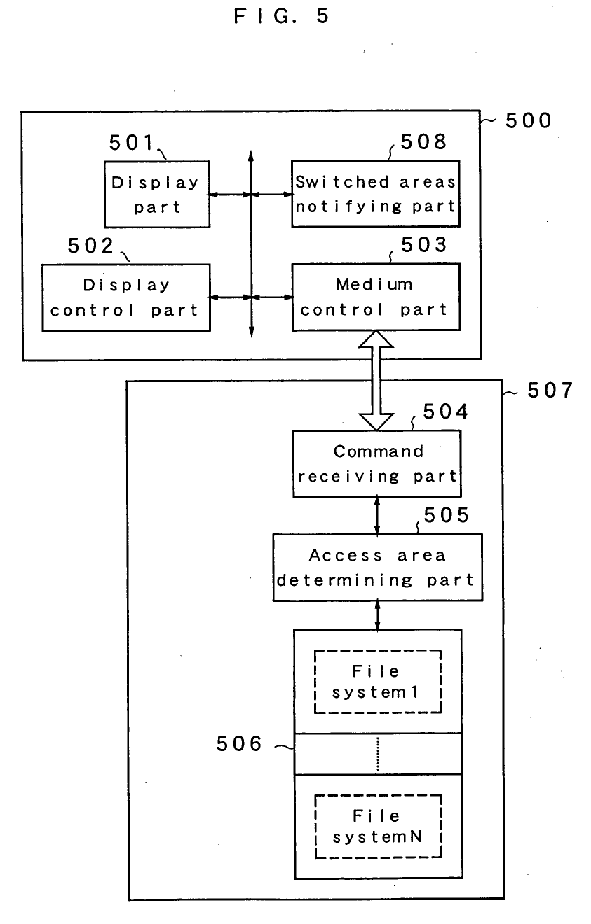

FIG. 5 is a block diagram showing the configuration of the information displaying device and the information medium according to a second embodiment of the present invention. Components 500 to 507 in FIG. 5 correspond to the components 100 to 107 shown in FIG. 1. The second embodiment is different from the first embodiment in that a switched areas notifying part 508 is provided within the information displaying device 500 in the second embodiment.

Each block of the information displaying device 500 as a device for notifying of used areas that has been configured is described. The display control part 502 designates a display area and outputs information to that effect, to the medium control part 503. The medium control part 503 issues a command to switch areas in order to access the designated area from the display control part 502, and outputs the command to the command receiving part 504 in the information medium 507. When the switched areas notifying part 508 is notified that the access areas in the information storing area 506 is switched, the switched areas notifying part 508 notifies the user about this information.

Meanwhile, the command receiving part 504 in the information medium 507 receives a command to switch areas from the medium control part 503, and when the access areas in the information storing area 506 are switched, the information medium 507 notifies information storing device 500 that the areas have been switched. The access area determining part 505 determines the access area on the basis of the command to switch areas that has been received by the command receiving part 504 from the medium control part 503. The information medium 507 reads information in the designated area of the information storing area 506 on the basis of the determination result of the access area determining part 505, and outputs the information to the information displaying device 500 from the information medium 507.

The information on the area obtained from the information medium 507 is displayed on the display part 501 according to the display method designated by the display control part 502.

FIG. 2 shows a conceptual diagram of information storing areas in the information medium 507 in the second embodiment in the same manner as in the first embodiment.

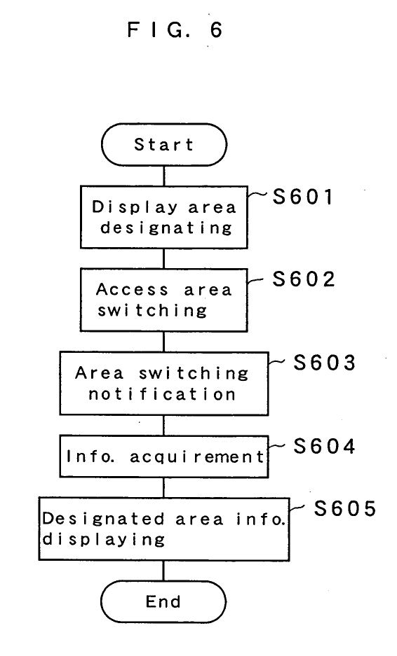

FIG. 6 is a flowchart showing the operations of the device for notifying of used areas and the information medium according to this embodiment of the present invention.

A case is described where information that is stored in the information storing area managed by the FAT 16 file system is accessed through the application that displays a list of stored information, and after that, one piece of information that is stored in the information storing area managed by the FAT 32 file system is described. In this case, first, the display control part 502 designates a display area. The medium control part 503 issues a request for switching the access areas to the information medium 507 (S601). The display control part 502 designates the FAT 32 file system and transmits a command to switch to the information storing area managed by the FAT 32 file system to the information medium 507 from the medium control part 503.

When the command receiving part 504 receives the command to switch to the FAT 32 file system, the information medium 507 switches the access areas (S602).

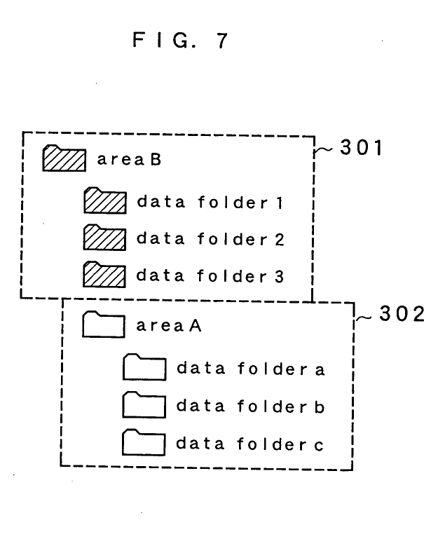

When the access areas are switched, the information medium 507 notifies the information storing device 500 that the areas have been switched. The switched areas notifying part 508, been notified that the access areas in the information storing area 506 have been switched, notifies the user about this information (S603). In the case a list of information stored within an area has already been displayed on the display part 501 as shown in FIG. 7, for example, and the data folder 1 shown in the area 301 is accessed, the color of the icon of the area 301 is changed to the color indicating that it is being utilized, shown as the hatched area, and the color of the icon shown in the area 302 is changed to the color indicating that it is not being utilized.

Next, when an area is determined by the access area determining part 505, the information medium 507 acquires information that is stored in the storing area (202 of FIG. 2) that is managed by the FAT 32 file system of the information storing area 506, and outputs the information to the information displaying device 500 (S604).

The data acquired from the information medium 507 is displayed on the display part 501 according to the display method determined by the display control part 502 (S605). Information is displayed in, for example, tree structure as shown by 301 of FIG. 3, on the display part 501.

Here, an information medium with two information storing areas that is managed by the two file systems, the FAT 32 and the FAT 16, is cited as the above-described example. The file systems are not limited to these two, but rather, a NTFS, a UDF or any other unique file systems may be used. In addition, the number of information storing areas is not limited to two, but rather, the same system can be implemented by repeatedly carrying out the respective steps shown in FIG. 6 while switching the file systems, as long as the number is integer (more than one).

In addition, the more than one information storing area may be managed by the same file system.

In addition, though an example is cited in the above where all of the information storing areas that exist in the information medium can be accessed, only the areas that can be accessed by the device from among the more than one information storing area may be selected and displayed. In the case of an information displaying device that has only the FAT 16 file system, for example, only the area 302 of FIG. 3 is displayed, and in the case of an information displaying device that has the two file systems, the FAT 16 and the FAT 32, the two areas 301 and 302 of FIG. 3 are displayed. Alternatively, in the case of an information displaying device that has the two file systems, the display control part 502 intentionally chooses to display only one of the two areas, and it is possible to limit access to an arbitrary area.

In addition, as for the display of information storing areas in this embodiment, the information managed by the FAT 16 file system is collected into one folder and displayed in the information managed by the FAT 32 file system. However, the information managed by the FAT 16 file system may be positioned at the same level as the information managed by the FAT 32 file system (one level above the tree structure). In addition, as long as the information within the area is displayed, a display method for aligning icons or any other display methods may be used without providing a tree structure.

In addition, though in this embodiment, the switched areas notifying part 508 makes a notification by changing the color of the icon on the display part 501 in S603, the method is not limited to this, as long as it is a method for making a notification that the areas are switched. The shapes of the icons may be changed, colors or thicknesses of the fonts of folders or file titles may be changed, or information may be added to them. Alternatively, the background of the display areas may be changed, dialogues may be displayed at the time of switching, or sound may be emitted. Furthermore, the switched areas notifying part 508 may be an access lamp in the information displaying device 500 to notify the switching of the areas by changing the color of light or by blinking.

In addition, though in this embodiment, the switched areas notifying part 508 exists within the information displaying device 500, it may be within the information medium 507, as long as it can make a notification that the areas are switched. A method for notifying by changing the color of light or by blinking when an access lamp or a display part exists on the information medium, a method for notifying that the areas are switched by means of speech sound when a sound generation part exists on the information medium and the like, for example, can be considered. In addition, the switched areas notifying part 508 may be outside of the information displaying device 500 or the information medium 507. In the case the information displaying device 500 is a personal computer and the information medium 507 is a semiconductor memory card, for example, a method for notifying by changing the color of light or by blinking at the time of area switching can be considered when an access lamp or an information display part is provided to an adapter for the semiconductor memory card. In the case the switched areas notifying part 508 exists outside the information displaying device, a device for notifying of used areas is configured so as to include the external notification part 508 in the information displaying device.

In addition, in FIG. 6, the step of S603 may be carried out after the designated area information has been displayed in S605. It is clear that the effects of notifying that the storing areas that are to be utilized have been changed are the same even when these steps are exchanged.

By using methods such as those described above, it becomes possible to notify the user that the storing areas that are to be utilized are changed in an information medium that has more than one information storing area managed by different file systems.

### Third Embodiment

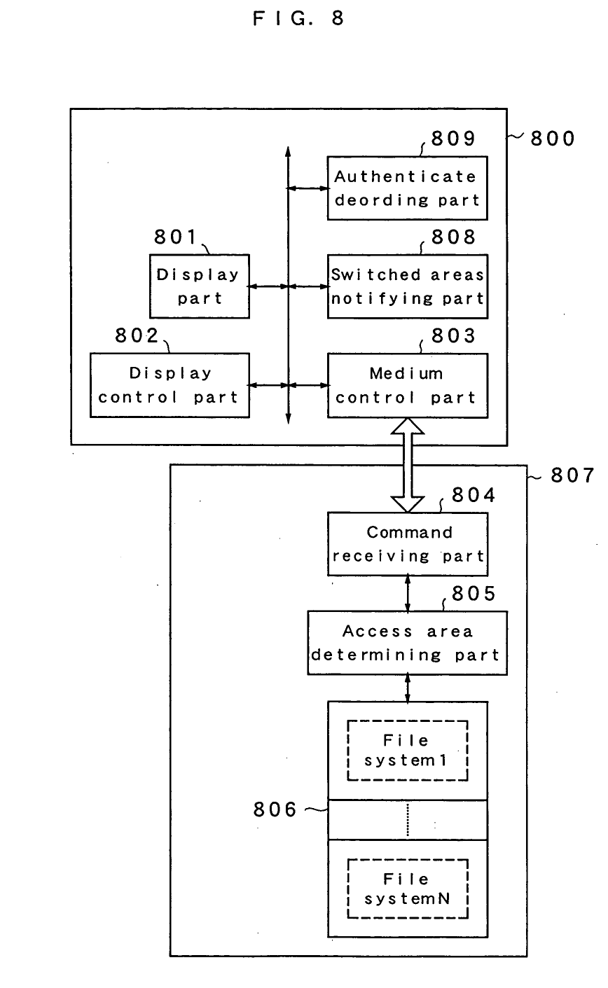

The information displaying device and the information medium according to a third embodiment of the present invention are described below. FIG. 8 shows the configurations of the information displaying device and the information medium according to this embodiment. Components 800 to 808 in FIG. 8 correspond to the components 500 to 508 shown in FIG. 5. The third embodiment is different from the second embodiment in that a authenticated area as the information storing area 806 and a authenticate decoding part 809 for decoding coded data are provided in the third embodiment.

Each block of the information displaying device as a device for notifying of used areas, which is configured as described above, is described below. The display control part 802 designates a display area and outputs information to that effect, to the medium control part 803. The medium control part 803 issues a command to switch areas in order to access the area that has been designated by the display control part 802, and outputs the command to the command receiving part 804 in the information medium 807. When the switched areas notifying part 808 is notified that the access areas in the information storing area 806 have been switched, the switched areas notifying part 808 notifies the user about this information. In addition, the authenticate decoding part 809 decodes the code by using a key for data encryption.

Meanwhile, the command receiving part 804 in the information medium 807 receives a command to switch areas from the medium control part 803, and when access areas in the information storing area 806 are switched, the information medium 807 notifies the information storing device 800 that areas have been switched. The access area determining part 805 determines an access area on the basis of a command to switch areas received by the command receiving part 804 from the medium control part 803. The information medium 807 reads information in the designated area of the information storing area 806 on the basis the determination result of the access area determining part 805, and outputs the information from the information medium 807 to the information displaying device 800.

The information on the area that has been obtained from the information medium 807 is displayed on the display part 801 according to the display method designated by the display control part 802.

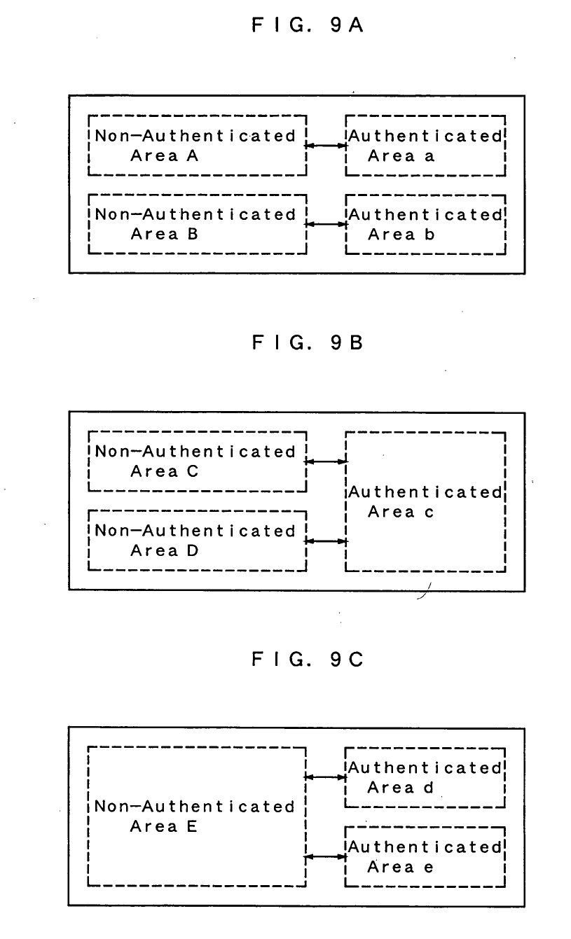

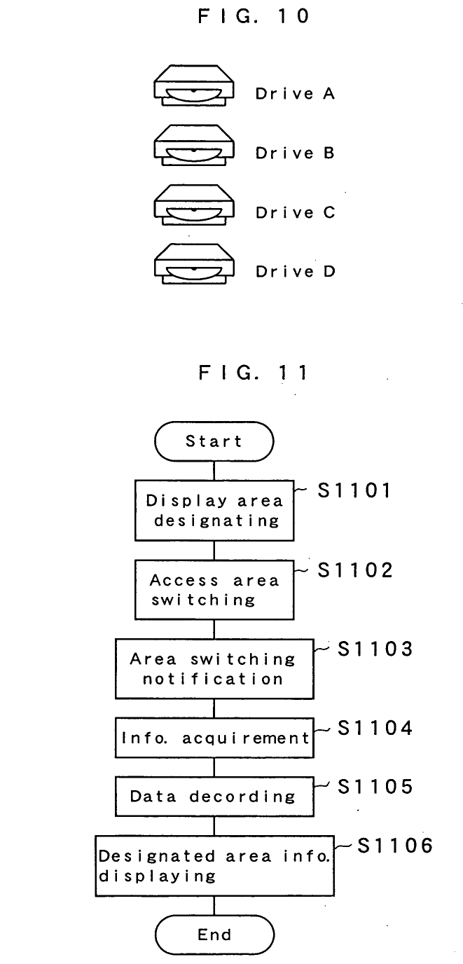

FIG. 9 are conceptual diagrams of the information storing area 806 according to this embodiment. FIG. 9A shows an example of an information storing area that has four information storing areas, where two authenticated areas a and b respectively correspond to two non-authenticated areas A and B in a one-on-one manner. That the non-authenticated area A is a area stored in accordance with, for example, the FAT 16 system, and the non-authenticated area B is an area stored in accordance with, for example, the FAT 32 system, and the authenticated areas a and b are areas recorded in accordance with file systems that are different from each other. In addition, FIG. 9B shows an example of three information storing areas, where one authenticated area c corresponds to two non-authenticated areas C and D. FIG. 9C shows an example of three information storing areas, where two authenticated areas d and e correspond to one non-authenticated area E. In FIGS. 9B and 9C also, it is assumed that the non-authenticated areas C and E are stored in accordance with the FAT 16 system, and the non-authenticated area D is stored in accordance with the FAT 32 system, while the authenticated areas c, d and e are stored in accordance with file systems that are different from each other.

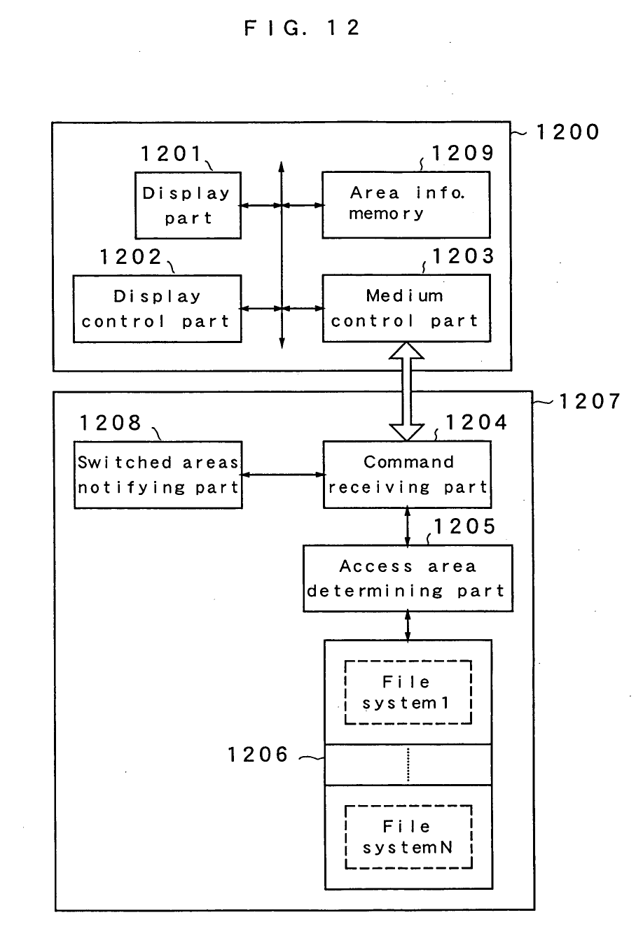

FIG. 10 shows a display example of the information storing area according to the third embodiment of the present invention. Different information storing areas are displayed as different drives. Here, an example is described where an area obtained by combining the non-authenticated area A and the authenticated area a is indicated as drive A, and an area obtained by combining the non-authenticated area B and the authenticated area b is indicated as drive B.

The flowchart showing the operation of the device for notifying of used areas according to the third embodiment of the present invention is described with reference to FIG. 11.

The information storing area 806 of the information medium 807, for example, has four areas as shown in FIG. 9A and displays the contents of encrypted data (such as music data and image data, for example) using the authenticated area by means of an application that shows a list of stored information. In this case, authentification must be carried out so that a key for encrypting data that exists within the authenticated areas a and b is acquired and the encryption is decoded and, therefore, a file system which can access the authenticated areas a and b is utilized. In addition, a file system for the non-authenticated area A is utilized to access the non-authenticated A and a file system for the non-authenticated area B is utilized to access the non-authenticated area B. The display control part 802 designates which is accessed the non-authenticated area A or the non-authenticated area B. A switching command between the non-authenticated area A and the authenticated area a, for example, is transmitted from the medium control part 803 to the command receiving part 804 in the medium 807. First, a display area is designated by the display control part 802 and a request for switching access areas is issued to the information medium 807 by the medium control part 803 (S1101).

The medium 807 switches access areas when the command receiving part 804 receives an area switching command (S1102).

When access areas are switched, the information medium 807 notifies the information storing device 800 that areas have been switched. The switched areas notifying part 808 is notified that access areas in the information storing area 806 have been switched, then notifies the user of this information (S1103). In the case the information displaying device 800 is, for example, an apparatus that has a means for outputting speech sound such as a speaker, a name showing the area is read out by speech sound or beeping sound is emitted.

In addition, according to another notification method, in the case a list of areas is displayed as a drive as shown in FIG. 10 in the display part 801, the color of the icon of the accessed drive A is changed to a color that indicates that the drive A is utilized and the color of other icons may be changed to the color that indicates that they are not utilized.

Next, the area is determined by the access area determining part 805 and information that is stored in an area where the non-authenticated area A and the authenticated area a in the information storing area 806 are combined is acquired so as to be outputted from the information medium 807 to the information displaying device 800 (S1104).

The information displaying device 800 displays data acquired from the information medium 807 on the display part 801 according to a display method that has been determined by the display control part 802 (S1105). It is assumed that, for example, image data within the drive A is acquired. In this case, image data is decoded on the basis of the key for the authenticated area a and the information of this image is displayed on the display part 801. In the case the acquired data is the playback time of music, the playback time and title of the music are displayed on the display part 801.

In the case information stored in the non-authenticated area B is displayed, the same process is repeated by transmitting a switching command to the non-authenticated area B and the certificate b respectively. By doing this, the access areas are switched and this switched area is notified to the user and information on the acquired area can be decoded and displayed.

Here, though an information medium with two information storing areas formed of the non-authenticated area A and the authenticated area a or the non-authenticated area B and the authenticated area b is cited in the above-described example, information storing areas are not limited to these two but, rather, other unique information storing areas may be used in the configuration. In addition, the number of the information storing areas is not limited to two but, rather, more than one information storing area obtains the same effects.

In addition, as shown in FIG. 9B, in the case there are two non-authenticated areas D, C and one authenticated area c, the authenticated area c is read out for the display in the same manner when either one of the non-authenticated areas is selected.

In addition, more than one information storing area may be areas managed by the same file system.

In addition, though in this embodiment an example where all of the information storing areas that exist in the information medium can be accessed is cited, only the areas that can be accessed as a device may be selected from among more than one information storing area so as to be displayed.

In addition, though information storing areas which are displayed as a drive are cited in this embodiment, a tree structure or any other display method may be used.

By using the above-described methods, it becomes possible to notify that utilized storing areas in information medium that has more than one information storing area managed by different file systems have been changed.

### Fourth Embodiment

An information displaying device and an information medium according to a fourth embodiment of the present invention are described below. The configurations of the information displaying device and information medium of this embodiment are described with reference to FIG. 8 in the same manner as the third embodiment. In addition, the information storing area is described with reference to FIG. 10 showing a conceptual diagram in the same manner as in the third embodiment and the operation is described with reference to FIG. 11 showing a flowchart in the same manner as the third embodiment. The fourth embodiment is another example that can be implemented with the configuration which is the same as that of the third embodiment.

Next, the operation of the device for notifying of used areas according to this embodiment is described with reference to FIG. 8.

First, the display control part 802 designates a display area and the medium control part 803 issues a request for switching access areas to the information medium 807 (S1101). In the case the information storing area 506 in the information medium 507 has more than one area as shown in FIG. 9C, it is necessary for the data that has been encrypted by using a key for encrypting data within the authenticated area d to be accessed by certification for the authenticated area d when encrypted data-stored in the non-authenticated area E is accessed. In addition, it is necessary to carry out certification for the authenticated area e in order to access data that has been encrypted by using a key for encrypting data within the authenticated area e. The display control part 802 within the application designates which data that has been encrypted by using a key for encrypting data in the authenticated area d, or in the authenticated area e, and the medium control part 803 transmits a command for switching to an information storing area that is formed of the non-authenticated area E and the authenticated area d or of the non-authenticated area E and the authenticated area e to the command receiving part 804 in the medium 807.

In the medium 807, when a command for switching areas is received by the command receiving part 804, access areas are switched (S1102).

When access areas have been switched, the information medium 807 notifies the information storing device 800 that areas have been switched. When it is noticed that access areas in the information storing area 806 have been switched, this information is notified to the user (S1103). In the case the information displaying device 800 is, for example, an apparatus that has a means for outputting speech sound such as a speaker, a name showing the area is read out by speech sound or beeping sound is emitted.

Next, the area is determined by the access area determining part 805 and the information that has been recorded in an area where the non-authenticated area E and the authenticated area d or the non-authenticated area E and the authenticated area e in the information storing area 506 are combined is acquired so as to be outputted from the information medium 807 to the information displaying device 800 (S1104).

The data that has been acquired from the information medium 807 is decoded in the authenticate decoding part 809 (S1105) and is displayed on the display part 801 according to the display method determined by the display control part 802 (S1106). The information that is stored in the area where the non-authenticated area E and the authenticated area d are combined is, for example, displayed as a drive C of FIG. 10 and the information that is stored in the area where the non-authenticated area E and the authenticated area e are combined is displayed as a drive D of FIG. 10.

By using the above-described method, it becomes possible to notify used areas by using different manners of displaying in the information medium that has more than one different authenticated area managed by the same file system.

In addition, it becomes possible to notify that the utilized storing area has been changed by emitting a beeping sound.

### Fifth Embodiment

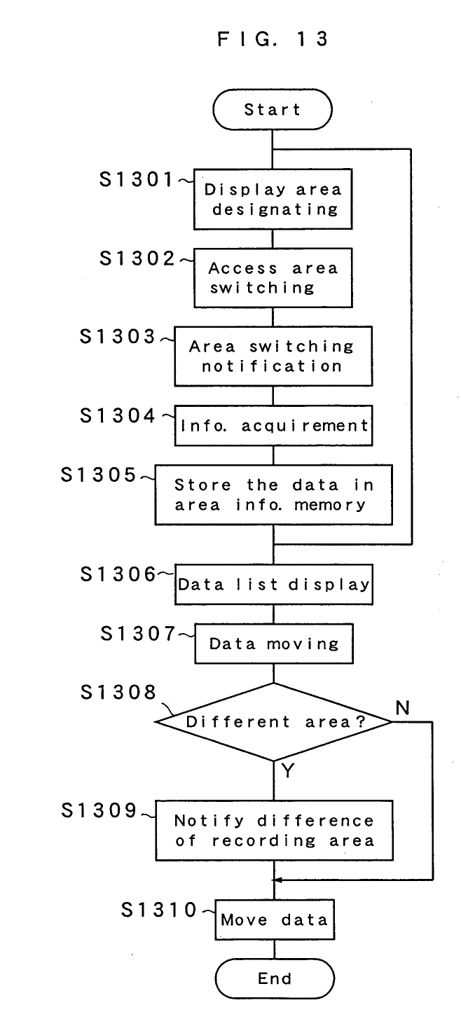

FIG. 12 is a block diagram showing the configurations of an information displaying device and an information medium according to a fifth embodiment of the present invention. Components 1200 to 1208 shown in FIG. 12 are the same as the respective components 500 to 508 of FIG. 5 according to the second embodiment. The fifth embodiment differs from the second embodiment in that the switched areas notifying part 508 within the information displaying device 500 according to the second embodiment exists within the information medium 1207 according to the fifth embodiment and an area information memory 1209 is provided within the information displaying device 1200 in the fifth embodiment.

The respective block of the information displaying device as a device for notifying of used areas are described. The display control part 1202 designates a display area and outputs information to this effect to the medium control part 1203. The medium control part 1203 issues a command for switching areas in order to access the area that has been designated by the display control part 1202 and outputs the command to the command receiving part 1204 in the information medium 1207. When the switched areas notifying part 1208 is notified that the access areas in the information storing area 1206 has been switched, then the notifying part 1208 notifies this information to the user.

Meanwhile, the command receiving part 1204 in the information medium 1207 receives a command for switching areas from the medium control part 1203 and when the access areas in the information storing area 1206 has switched the information medium 1207 notifies the information storing device 1200 that the areas have switched. The access area determining part 1205 determines the access area on the basis of the command for switching areas that has been received by the command receiving part 1204 from the medium control part 1203. The information medium 1207 reads information on the designated area in the information storing area 1206 on the basis of the determination result of the access area determining part 1205 and outputs the information from the information medium 1207 to the information displaying device 1200.

The information on the area obtained from the information medium 1207 is displayed on the display part 1201 according to the display method designated by the display control part 1202.

The display control part 1202 designates a display area and outputs it to the medium control part 1203. As a result of the sequential operation, the information storing areas have been switched and at the same time, the information on the area is displayed. The area information memory 1209 stores area information that has been outputted to the information displaying device 1200 by the information medium 1207. The area information is, for example, stored in a RAM within the apparatus or stored in a hard disc as a file. The area information that has been stored in the area information memory 1209 is displayed on the display part 1201 by the display control part 1202 according to the designated display method.

Here, though the switched areas notifying part 1208 is provided in the information medium 1207, it may be provided in the information displaying device 1200 or may be provided in an adapter or the like outside of this system. This device for notifying of used areas of the fifth embodiment is formed so as to include the switched areas notifying part 1208 in addition to the information displaying device 1200 shown in FIG. 12.

The information storing area 1206 in the information medium 1207 according to the fifth embodiment is described with reference to FIG. 2 showing a conceptual diagram in the same manner as in the first and second embodiments. In addition, a display example of the information storing area is described with reference to FIG. 3 in the same manner as in the first and second embodiments.

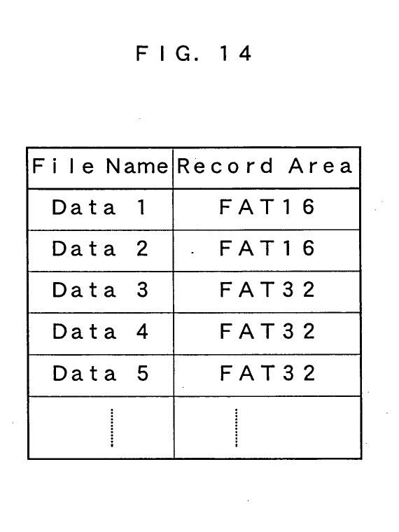

The operations of the device for notifying of used areas and of the information medium according to the fifth embodiment of the present invention are described with reference to the flowchart of FIG. 13.

First, the display control part 1202 designates a display area and the medium control part 1203 issues a request for switching access areas to the information medium 1207 (S1301). A list of information stored in all of the information storing areas is acquired, for example, by means of the application for displaying a list of stored information. In this case, the display control part 1202 within the application designates the FAT 32 file system and the medium control part 1203 transmits a command for switching to the information storing area managed by the FAT 32 file system to the command receiving part 1204 of the information medium 1207.

When the command receiving part 1204 receives a command for switching to the FAT 32 file system, the information medium 1207 switches the access areas (S1302).

When the access areas are switched, the information medium 1207 notifies the information storing device 1200 that the areas have been switched. When the switched areas notifying part 1208 is notified that the access areas in the information storing area 1206 have been switched, the notifying part 1208 notifies this information to the user (S1303). In the case of this embodiment, the switched areas notifying part 1208 exists in the information medium 1207. In the case an access lamp is provided in a semiconductor memory card, for example, a method for notifying that the areas have been switched by blinking the access lamp can be considered.

Next, when the area is determined by the access area determining part 1205 and the information stored in the storing area (202 of FIG. 2) that is managed by the FAT 32 file system in the information storing area 1206, this information is outputted from the information medium 1207 to the information displaying device 1200 (S1304). The data that has been acquired from the information medium 1207 is stored in the area information memory 1209 (S1305).

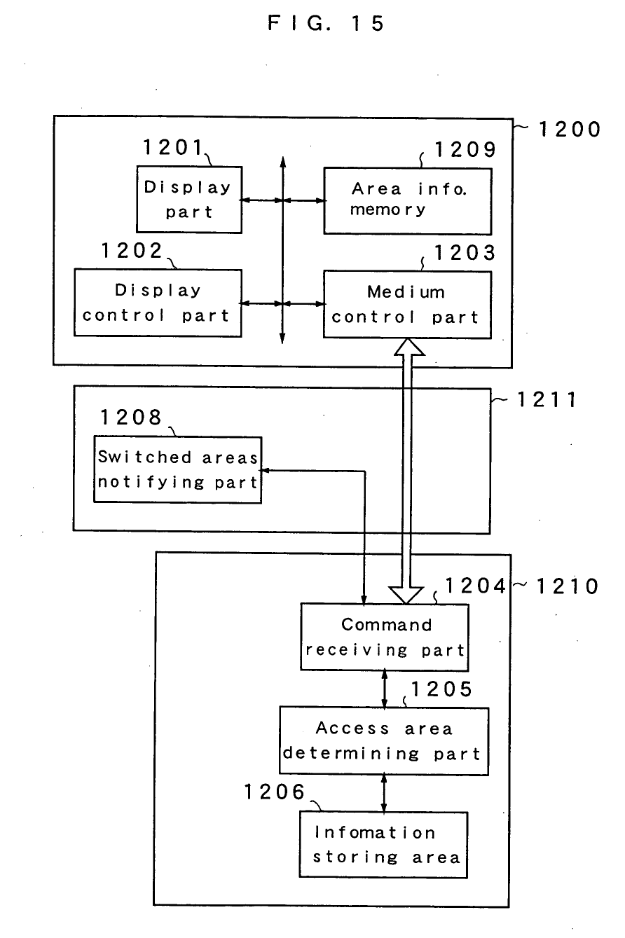

Then, the respective steps S1301 to S1305 are repeated and the obtained information is stored in the area information memory 1209 while switching more than one information storing area that exists in the information storing area 1206. When required repetition is completed, the procedure proceeds to S1306. FIG. 14 shows a conceptual diagram of the area information memory 1209 according to the fifth embodiment of the present invention. The file name of data, the storing area and the like of data are stored in the area information memory 1209.

In S1306, a list of data in the information storing area 1206 is displayed through the above-described application. As shown in 301 of FIG. 3, the information is displayed, for example, in a tree structure.

Next, an operation of moving data is carried out through the application (S1307).

In S1308, information on which storing area stores the data to be moved is acquired from the data in the area information memory 1209, and it is determined whether or not the information storing areas before the movement and after the movement are managed by the same file system. In the case the information storing areas before the movement and after the movement are managed by the same file system, the procedure directly proceeds to S1310 and the data is moved. In the case they are managed by different file systems, a message that the data is to be moved to a different information storing area is notified to the user (S1309). When the file of data 2 that is in an information storing area managed by the FAT 16 file system is intended to move to an information storing area managed by the FAT 32 file system through the application as shown in FIG. 14, for example, the following message dialogue is displayed, notifying the area information to the user.

“Data 2 is data in an area of FAT 16. You are trying to move data 2 to an area of FAT 32. Would you like to move?”

In the case the user confirms afterwards the procedure proceeds to S1310 and the data is moved.

Here, though in the above-described example an information medium with two information storing areas which are managed by the two file systems, the FAT 32 and the FAT 16 is cited, file systems are not limited to these two, but rather a NTFS, a UDF or any other unique file systems may be used. In addition, the number of information storing areas is not limited to two, but rather, the same system can be implemented as long as there is more than one information storing areas.

In addition, areas which are managed by the same file system may exist in more than one information storing areas.

In addition, the steps of S1305 and S1306 shown in FIG. 13 may be switched.

In addition, though in the above-described example movement of data is cited, it is preferable to notify area information to the user concerning copying of data in the same manner as described above.

Next, FIG. 15 shows a modification of the fifth embodiment. In this modification, an adapter 1211 makes a connection between an information medium 1210 and the information displaying device 1200. The switched areas notifying part 1208 is provided within the adapter 1211. The information medium 1211 has the command receiving part 1204, the access area determining part 1205 and the information storing area 1206. The adapter 1211 connects, for example, a semiconductor memory to a PC which is an information displaying device. Also in this case, the switched areas notifying part 1208, which is provided in the adapter, can display that the areas to be accessed have been switched.

By using the above-described method, it can be notified that the used storing area has been changed in an information medium that has more than one information storing area managed by different file systems.

In addition, an area information memory is provided and, thereby, once a list of information is prepared, the application can determine whether the file systems of the area that is stored and the area after the movement or after being copied are the same or not without directly accessing the data on the information medium at the time of the movement or copying of the data, leading to an increase in the speed of processing.

Here, the device for notifying of used areas and method for notifying of used areas which are described in each of the above-described embodiments can be at least partly implemented by means of software and this can be stored in storing medium that can be read by a computer device so as to be distributed or the like.

The device for notifying of used areas and the method for notifying of used areas of an information medium according to the present invention can enhance convenience of the user who selects an area to be utilized by displaying the information on the area in the case an information medium requiring more than one file system is accessed. The present invention can be applied to a wide variety of items, such as personal computers, a variety of portable information terminals and digital AV apparatuses.

Though the preferred embodiments are described herein, a variety of other embodiments and modifications which occur to those skilled in the art fall in the scope and the gist of the present invention and such other embodiments and modifications are included in the below described claims. The text of Japanese priority application No. 2003-395200 filed on Nov. 26, 2003 is hereby incorporated by reference.

1. A device for notifying of used areas that accesses an information medium having a plurality of information storing areas managed using individual file systems, the device comprising:
a medium control part which switches information storing areas for accessing said information medium; and
a display control part which displays information in said plurality of information storing areas after said information storing areas have been switched to accessible areas.

2. A device for notifying of used areas according to claim 1, wherein
said display control part displays information in a specific area selected from said plurality of information storing areas.

3. A device for notifying of used areas according to claim 1, wherein
said display control part displays a plurality of information storing areas in a hierarchical manner.

4. A device for notifying of used areas according to claim 1, comprising:
an area information memory which stores information concerning information storing areas of said information medium.

5. A device for notifying of used areas according to claim 1, comprising:
a switched areas notifying part which notifies that an information storing area to be utilized has been switched at the time of switching of said information storing areas.

6. A device for notifying of used areas according to claim 5, wherein
said switched areas notifying part notifies that a file system to which data is transferred is different from a file system from which the data is transferred when the data is moved or copied among said plurality of information storing areas.

7. A device for notifying of used areas according to claim 5, comprising:
an area information memory which stores information concerning information storing areas of said information medium, wherein
said switched areas notifying part refers to said area information memory and notifies that a file system to which data is transferred is different from a file system from which the data is transferred when the data is moved or copied among said plurality of information storing areas.

8. A device for notifying of used areas according to claim 5, wherein
said switched areas notifying part is provided in said information medium.

9. A device for notifying of used areas according to claim 5, wherein
said switched areas notifying part is provided in an adapter connected to said information medium.

10. A device for notifying of used areas according to claim 5, wherein
said switched areas notifying part changes a mode of display whenever the information storing area is switched.

11. A device for notifying of used areas according to claim 10, wherein
said switched areas notifying part notifies that the information storing area has been switched using a change of color.

12. A device for notifying of used areas according to claim 10, wherein
said switched areas notifying part notifies that the information storing area has been switched using a change of light.

13. A device for notifying of used areas according to claim 10, wherein
said switched areas notifying part notifies that the information storing area has been switched using sound.

14. A method for notifying of used areas in a device for notifying of used areas that accesses an information medium having a plurality of information storing areas managed using individual file systems, the method comprising:
a medium control step of switching said information storing areas for accessing said information medium; and
a display control step of displaying information on said plurality of information storing areas after said information storing areas have been switched to accessible areas.

15. A method for notifying of used areas according to claim 14, wherein
said display control step displays information selecting a specific area is selected from said plurality of information storing areas.

16. A method for notifying of used areas according to claim 14, wherein
said display control part displays a plurality of information storing areas in a hierarchical manner.

17. A method for notifying of used areas according to claim 14, comprising:
a step of storing information concerning an information storing area in an area information memory.

18. A method for notifying of used areas according to claim 14, comprising:
a switched area notifying step of notifying that the information storing area to be utilized has been switched at the time of switching of said plurality of information storing areas.

19. A method for notifying of used areas according to claim 18, wherein
said switched area notifying step notifies that a file system to which data is transferred is different from a file system from which the data is transferred when the data is moved or copied among said plurality of information storing areas.

20. A method for notifying of used areas according to claim 18, comprising:
a step of storing information concerning an information storing area in an area information memory, wherein
said switched area notifying step notifies that said area information memory is referred and a file system to which data is transferred is different from a file system from which the data is transferred when the data is moved or copied among said plurality of information storing areas.

21. A method for notifying of used areas according to claim 18, wherein
said switched area notifying step changes a mode of display whenever the information storing area is switched.

22. A method for notifying of used areas according to claim 21, wherein
said switched area notifying step notifies that the information storing area has been switched using a change of color.

23. A method for notifying of used areas according to claim 21, wherein
said switched area notifying step notifies that the information storing area has been switched using a change of light.

24. A method for notifying of used areas according to claim 21, wherein
said switched area notifying step notifies that the information storing area has been switched using sound.

25. A computer readable medium storing a method for notifying of used areas as a computer executable program, wherein
said method for notifying of used areas is a method for notifying of used areas in a device for notifying of used areas which accesses an information medium having a plurality of information storing areas managed using individual file systems, the method comprising:
a medium control step of switching said information storing areas for accessing said information medium; and
a display control step for displaying information on said plurality of information storing areas after said information storing areas have been switched to accessible areas.
